(19) United States
(12) Patent Application Publication
(10) Pub. No.: US 2010/0271924 A1
(43) Pub. Date: Oct. 28, 2010

(54) OPTICAL APPARATUS

(76) Inventors: Takatoshi Yukimasa, Osaka (JP); Masahiro Yamazaki, Osaka (JP); Shinsuke Hatanaka, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/766,947

(22) Filed: Apr. 26, 2010

(30) Foreign Application Priority Data
Apr. 27, 2009 (JP) 2009-107549
Apr. 9, 2010 (JP) 2010-90314

(51) Int. Cl. G11B 7/135; G02B 7/00; B32B 38/04

(52) U.S. Cl. 369/112.01; 359/811; 156/252; G9B/7

(57) ABSTRACT

An optical apparatus according to the present invention comprises an optical base having a bonding surface, and an optical component fixedly bonded to the bonding surface with an adhesive. The optical base has an open hole formed in the bonding surface. The open hole is filled with the adhesive. The optical component contacts the open hole so that a part of the open hole is left unclosed.

### BACKGROUND OF THE INVENTION

1. Field of The Invention

The present invention relates to an optical apparatus provided in an optical pickup apparatus in which optical components, such as a lens, prism, polarizing plate and photodetector, are securely bonded to a bonding surface of an optical base with an adhesive, and a method for manufacturing the optical apparatus, and further relates to an optical pickup apparatus and an optical disc drive apparatus. The present invention more particularly relates to a technology for addressing the needs of precision improvement in assembling optical components to deal with increasingly shorter wavelengths of a semiconductor laser for achieving a higher recording density.

The documents of Japanese Patent Application No. 2009-107549 filed on Apr. 27, 2009 are incorporated in its entirety, including the specification, drawings, and Scope of Claim, in the specification of the present application by reference.

2. Description of The Related Art

Conventional examples of an optical information recording medium having a large capacity are CD (compact disc), CD±R, CD±RW, DVD (digital versatile disc), DVD±R and DVD±RW. The latest optical information recording medium increasingly widespread these days is BD (blue-ray disc) where high-definition images can be stored in a high recording density. Optical apparatuses designed to record and reproduce data with respect to these optical discs generally use an optical pickup apparatus that employs a semiconductor laser by which a signal is read from and written in the optical discs.

The optical pickup apparatus guides a beam outputted from the semiconductor laser to an object lens unit through optical components mounted on an optical base and converges micro beam spots on an optical disc surface and further make them reflect thereon, and guide the reflected light entering the object lens unit to a photoelectric conversion element through the optical components so that a reproduction signal and a control signal are finally obtained.

To focus-control the beam, a main pattern is divided into four patterns and signals of the four patterns are calculated to obtain a focus error signal because the shape of a control spot on the main pattern changes with a focus error amount. Then, a distance between the object lens unit and the disc is controlled so that the focus error signal is adjusted to zero. To track-control the beam, signals outputted from control spots on two divided sub patterns are calculated to obtain a tracking error signal. Then, the object lens unit is moved in a disc-radius direction so that the tracking error signal is adjusted to zero.

The micro beam spot on the signal recording surface of the disc has a diameter of approximately 0.6 μm in DVD, and the diameter is even smaller in BD (blue-ray disc) than in DVD, which is 0.3 μm. There should be naturally an attempt to similarly reduce aberration to a diffraction limit, nevertheless, a higher precision is demanded in assembling the optical components because of shorter wavelengths in BD as well as precision of each optical component.

The optical pickup apparatus often used in a laptop personal computer is desirably smaller and thinner. The optical component, laser element, and photoelectric element are conventionally assembled by bonding. These components should be bonded with a high precision, and the bonding precision is desirably sustained as long as possible.

The bonding of the optical components is described referring to the conventional technology recited in the disclosed Japanese Patent Document (Japanese Patent Laying-Open No. 04-242209). FIG. 10 is an exploded perspective view of a section of an optical base to which a lens is bonded in a conventional optical pickup apparatus. FIG. 11 is a longitudinal front view of the lens and the optical base bonded to each other. An optical base 1 is provided with a hollowed housing section 2 formed in the shape of a reversed trapezoid for securely housing a lens 5 in a predetermined positional relationship. On the left and right sides of the hollowed housing section 2, a pair of side surfaces 3 and 4 respectively serving as bonding surfaces of the optical base is formed in the shape of a truncated chevron. An adhesive 6 is applied to the side surfaces 3 and 4, and a cut-end surface of the lens 5 is securely bonded to the side surfaces 3 and 4 with the adhesive 6.

The conventional technology has the following bottleneck in the pursuit of increasing precision in assembling optical components to deal with increasingly shorter wavelengths of a semiconductor laser for achieving a higher recording density. FIGS. 12A and 12B respectively illustrate states of the applied adhesive 6 in a cross section B before and after the lens is bonded. As illustrated in FIG. 12A, the adhesive 6 is applied to the side surfaces 3 and 4 of the hollowed housing section 2 by using an injection needle. When the lens 5 is pressed against the side surfaces 3 and 4, the adhesive 6 spreads along the side surfaces 3 and 4 as illustrated in FIG. 12B, and the lens 5 is securely bonded thereto as the adhesive 6 is cured.

FIG. 13 illustrates a distribution 7 of a residual internal stress of the adhesive 6 in the cross section B. The residual internal stress conventionally has a largest value at a center position in a thickness direction of the lens 5, which means that the residual internal stress is maximized at the center position in the lens thickness direction when the adhesive 6 is cured. When the residual internal stress is thus larger toward the center position in the thickness direction, the lens 5 easily loses its contact with the side surfaces 3 and 4 when the adhesive 6 is deteriorated over time or the stress is released due to high temperatures, deteriorating its bonding precision. Thus, the conventional technology is associated with difficulty in accurately bonding the lens and sustaining the bonding precision afterwards.

### SUMMARY OF THE INVENTION

Therefore, a main object of the present invention is to bond optical components to a bonding surface of an optical base with a high precision and sustain the bonding precision over a period of time to deal with increasingly shorter wavelengths of a semiconductor laser for achieving a higher recording density.

An optical apparatus according to the present invention comprises:

an optical base having a bonding surface; and

an optical component fixedly bonded to the bonding surface with an adhesive, wherein

the optical base has an open hole formed in the bonding surface,

the open hole is filled with the adhesive, and

the optical component contacts the open hole so that a part of the open hole.

According to a preferred mode of the present invention, a length dimension of the open hole along a first direction in parallel with an optical-axis direction of the optical component is smaller than a length dimension of an optical base contacting portion of the optical component along the first direction.

According to another preferred mode of the present invention, an entire width of the open hole along the first direction is in contact with the optical component.

According to still another preferred mode of the present invention, a length dimension of the open hole along a second direction orthogonal to the first direction is larger than a length dimension of the optical base contacting portion along the second direction.

According to still another preferred mode of the present invention, the optical base contacting portion of the optical component has the shape of a bulging curved surface in view from the optical-axis direction of the optical component.

According to still another preferred mode of the present invention, the optical base has a hollowed housing section tapered downward in view from the optical-axis direction of the optical component in the bonding surface, a length dimension of the hollowed housing section along the first direction in parallel with the optical-axis direction is equal to or larger than a length dimension of the optical base contacting portion of the optical component along the first direction, and the open hole is provided in each of side surfaces of the hollowed housing section. The “tapered downward” denotes such a shape that the hollowed housing section opens in wider dimensions toward an upper section thereof.

According to still another preferred mode of the present invention, the bonding surface and the optical base contacting portion of the optical component respectively have the shape of a flattened surface.

In the preferred modes described so far, the open hole is formed in the section of the bonding surface of the optical base where the optical component contacts and filled with the adhesive. Therefore, the adhesive is applied into the open hole and around the open hole, and the optical component is fixedly bonded to the bonding surface with the adhesive. The adhesive is sufficiently retained in the open hole and pushed out of the open hole when the optical component is pressed against the bonding surface and then spreads on the bonding surface. Therefore, the optical component is bonded to the bonding surface with an adequate volume of adhesive. A part of the open hole makes no contact with the optical component, which allows the adhesive pushed out of the open hole by the pressure applied thereto by the optical component to spread on the bonding surface. The adhesive thus supplied helps the optical component to fit along the bonding surface, and the optical component can be bonded with a high precision by an adequate volume of adhesive. A part of the open hole with no contact with the optical component serves to alleviate imbalanced distribution of a residual internal stress of the post-drying adhesive. As a result, the optical component can be accurately bonded at the right position over a long period of time.

An optical pickup apparatus according to the present invention comprises:

a light source;

the optical apparatus according to the present invention for introducing a luminous flux from the light source to an optical disc; and

a light-sensitive element for receiving the luminous flux reflected from the optical disc.

An optical disc drive apparatus according to the present invention comprises:

the optical pickup apparatus according to the present invention; and

a servo control apparatus for focus-controlling the optical pickup apparatus.

In these apparatuses, wherein the optical component (lens, prism, polarizing plate, or photodetector) can be reliably bonded to the optical base with a high precision over a long period of time, operations such as tracking control and focus control using the optical pickup can be constantly performed with a high accuracy. This advantage contributes to the improvement of precision demanded in assembling optical components to deal with increasingly shorter wavelengths of a semiconductor laser for achieving a higher recording density.

A method for manufacturing an optical apparatus according to the present invention is a method for manufacturing an optical apparatus comprising an optical base having a bonding surface and an optical component fixedly bonded to the bonding surface with an adhesive, including:

a first step for forming an open hole in the bonding surface and filling the open hole with the adhesive;

a second step for mounting the optical component on the bonding surface so that the optical component contacts the open hole with a part of the open hole making no contact with the optical component; and

a third step for fixedly bonding the optical component to the bonding surface by curing the adhesive.

According to the present invention, the open hole is formed in the bonding surface of the optical base, and dimensions of the open hole and a dimensional relationship between the open hole and the optical component are suitably set so that the pressure applied to the adhesive by the optical component is increased. Accordingly, the adhesive pushed out of the open hole can spread in a large area of the bonding surface. According to the structure, the optical component can be bonded to the bonding surface with a higher precision, and the adhesive pushed out of the open hole can be extensively spread on the bonding surface, which alleviates imbalanced distribution of the residual internal stress of the post-curing adhesive. Further, the bonding strength thereby obtained can be sustained over a long period of time. In the production of an optical pickup apparatus for BD (blue-ray disc) for which a high assembling precision is demanded, therefore, a good product quality can be ensured.

The advantageous technology according to the present invention is useful in an optical disc drive apparatus characterized in a high recording density in which a short-wavelength semiconductor laser is used, particularly in an optical pickup apparatus required to perform accurate tracking control and focus control in a blue-ray disc driver. The technology is further useful in an in-vehicle optical disc drive apparatus used in an environment under difficult conditions.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a block diagram of an optical disc drive apparatus according to a preferred embodiment 1 of the present invention.

FIG. 2 is an illustration of an optical system in an optical pickup apparatus according to the preferred embodiment 1.

FIG. 3 is an exploded perspective view of an optical component mounting structure in the optical pickup apparatus according to the preferred embodiment 1.

FIG. 4 is a longitudinal front view of the optical component mounting structure according to the preferred embodiment 1.

FIG. 5A is a drawing 1 illustrating a state of an applied adhesive in the optical component mounting structure according to the preferred embodiment 1.

FIG. 5B is a drawing 2 illustrating a state of the applied adhesive in the optical component mounting structure according to the preferred embodiment 1.

FIG. 6 is a longitudinal side view of the optical component mounting structure according to the preferred embodiment 1 (illustrating a portion A of FIG. 4 in cross section).

FIG. 7 is a perspective view of an optical component mounting structure in an optical pickup apparatus according to a preferred embodiment 2 of the present invention.

FIG. 8A is a sectional view of the illustration in FIG. 7 according to the preferred embodiment 2 in view from a direction H (first direction).

FIG. 8B is a sectional view of the illustration in FIG. 7 according to the preferred embodiment 2 in view from a direction V (second direction).

FIG. 9 is an illustration of a modified embodiment of an open hole shape according to the present invention.

FIG. 10 is an exploded perspective view of an optical component mounting structure in an optical pickup apparatus according to a conventional technology.

FIG. 11 is a longitudinal front view of the optical component mounting structure according to the conventional technology.

FIG. 12A is a longitudinal side view 1 illustrating the spread of an adhesive in a cross section B illustrated in FIG. 11 according to the conventional technology.

FIG. 12B is a longitudinal side view 2 illustrating the spread of the adhesive in the cross section B illustrated in FIG. 11 according to the conventional technology.

FIG. 13 illustrates an internal pressure distribution of the adhesive in the cross section B in a lens bonding portion according to the conventional technology.

### DETAILED DESCRIPTION OF THE INVENTION

### Preferred Embodiment 1

FIG. 1 is a block diagram of an optical disc drive apparatus according to a preferred embodiment 1 of the present invention. The optical disc drive apparatus has an optical pickup apparatus 100, a servo control apparatus 103, a spindle motor 107, and a servo drive circuit 108. The optical pickup apparatus 100 has an optical system including an object lens unit 15, and an actuator 102 equipped with the object lens unit 15. The servo control apparatus 103 has a focus detector circuit 104, a digital signal processor (hereinafter, referred to as DSP) 105, and a central processing unit (hereinafter, referred to as CPU) 106.

A laser beam reflected from an optical disc 18 attached to the spindle motor 107 is guided into the optical system from the object lens unit 15 of the optical pickup apparatus 100 and enters a photosensor (not shown). The photosensor converts the laser beam into an electrical signal and transmits the electrical signal to the focus detector circuit 104 of the servo control apparatus 103. The focus detector circuit 104 generates a focus servo signal based on the electrical signal supplied from the photosensor and transmits the generated focus servo signal to the DSP 105. The DSP 105 generates a drive voltage waveform for driving the actuator 102 based on the focus servo signal supplied from the focus detector circuit 104 and a command supplied from the CPU 106, and transmits the generated drive voltage waveform to the servo drive circuit 108. The servo drive circuit 108 generates a drive voltage based on the drive voltage waveform supplied from the DSP 105, and drives the actuator 102 using the drive voltage. When the actuator 102 is driven, a position of the object lens unit 15 relative to the optical disc 18 changes. The control operation described so far is repeated so that the laser beam is focus-controlled.

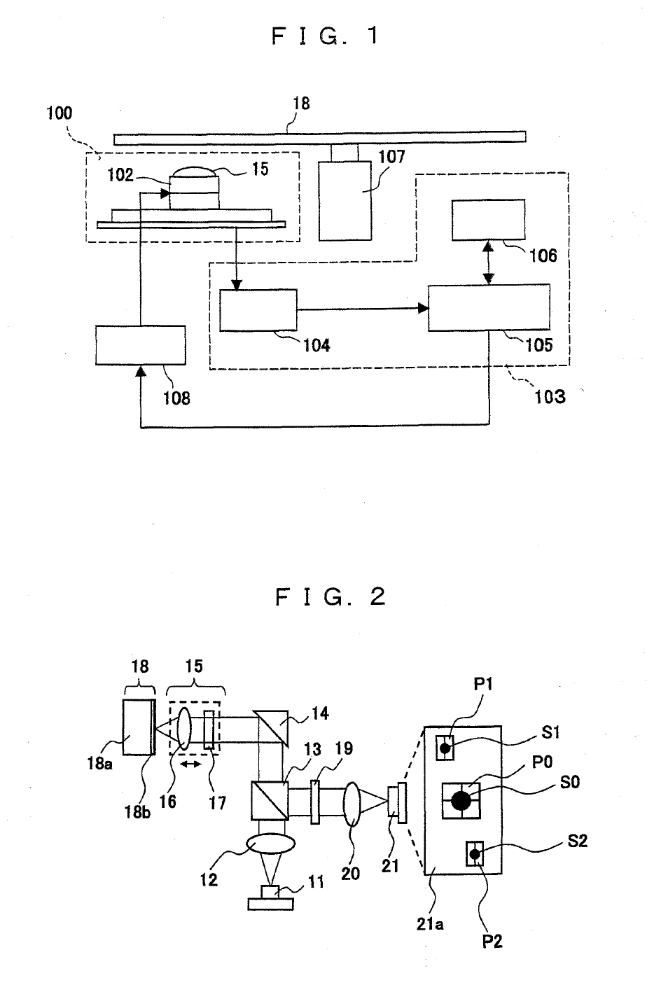

FIG. 2 is an illustration of the optical pickup apparatus 100 which is an optical apparatus according to the preferred embodiment 1. In the example shown in the drawing, the 3-beam method is employed for a tracking error detection signal, and the astigmatism method is employed for a focus error detection signal.

A light beam emitted from a semiconductor laser 11 is converted into parallel rays by a relay lens 12 and enters a beam splitter 13, and the light beam passes through a prism 14 and further the object lens unit 15, and forms micro beam spots on a signal recording surface 18b of the optical disc 18. The optical disc 18 has the signal recording surface 18b on one or both surfaces of a medium 18a made of resin, and signals are recorded on tracks on the signal recording surface 18b. The object lens unit 15 has an optical system equipped with an object lens 16, an achromatic lens 17 for finely correcting aberration, and an electromagnetic drive system where a coil and a magnet are used (not shown). The object lens unit 15 drives the optical system using the electromagnetic drive system to scan the tracks on the signal recording surface 18b using the micro beam spots, and controls the tracks to lessen the aberration of the micro beam spots (tracking control and focus control).

The optical disc 18 is rotated by a motor (not shown), and the light beam reflected from the signal recording surface 18b of the rotating optical disc 18 passes through the object lens unit 15 and the prism 14 to be reflected by the beam splitter 13, and then passes through a diffraction grating 19 and a cylindrical lens 20 to be finally received by a light receiving surface 21a of a light-sensitive element 21. The light receiving surface 21a has a main pattern P0 and sub patterns P1 and P2, and control spots S0, S1 and S2 are irradiated on these patterns.

In the structure described above, the semiconductor laser 11 constitutes a light source, and the relay lens 12, beam splitter 13, object lens unit 15, prism 14, diffraction grating 19, and cylindrical lens 20 constitute an optical apparatus.

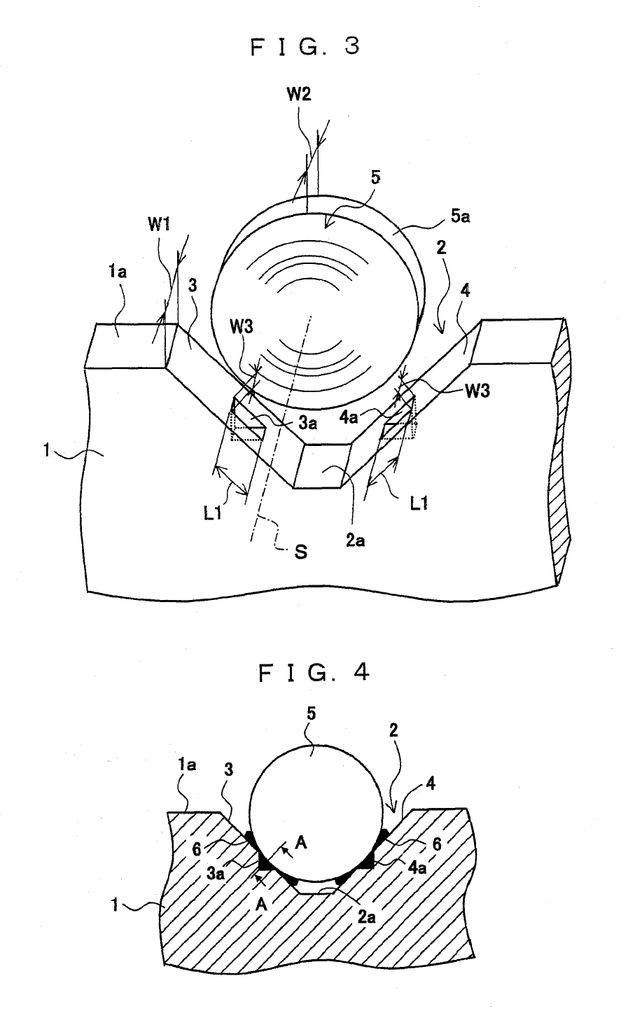

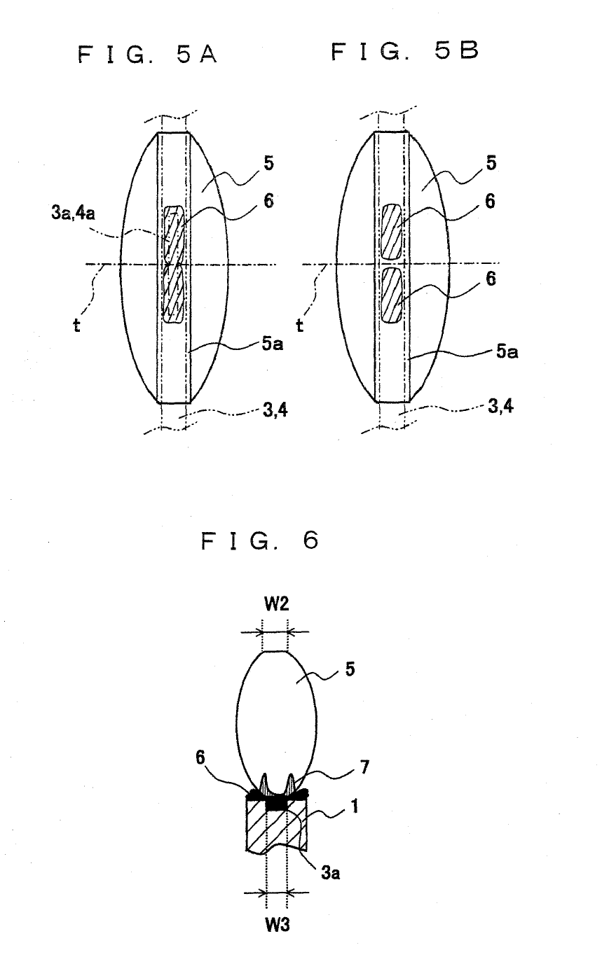

FIG. 3 is an exploded perspective view illustrating a portion of the optical base 1 of the optical pickup apparatus according to the preferred embodiment 1 to which the lens (optical component) 5 is attached. FIG. 4 is a longitudinal front view of a state where the lens 5 is bonded to the optical base 1. FIGS. 5A and 5B are longitudinal side views illustrating the state where the lens 5 is bonded to the optical base 1 (cross section A illustrated in FIG. 4). The lens 5 has a circular shape in view from an optical-axis direction S, and an optical base contacting portion of the lens 5 is curved in a bulging shape toward an outer side of the lens in view from the optical-axis direction S. The lens 5 according to the present preferred embodiment is securely bonded to a bonding surface 1a with an adhesive 6 so that the optical-axis direction S thereof is substantially in parallel with the bonding surface 1a of the optical base 1.

The bonding surface 1a of the optical base 1 is provided with a hollowed housing section where the lens 5 is fixedly housed in a predetermined positional relationship. The hollowed housing section 2 is formed in the shape of a reversed trapezoid along a direction in parallel with the optical-axis direction S of the lens 5 (first direction) by hollowing an entire width of the optical base 1. The lens 5 is housed in the hollowed housing section 5, and side surfaces 3 and 4 of the hollowed housing section 2 having the lens 5 bonded thereto have such a downward-tapered shape that the hollowed housing section 2 opens in wider dimensions upward in view from the first direction. More specifically, the side surfaces 3 and 4 are bilaterally symmetric to each other, and make the tilt angle of 45 degrees to the bonding surface 1a, while making the opening angle of 90 degrees to each other. A width dimension W1 of the hollowed housing section 2 having the lens 5 bonded thereto in the first direction (equal to a width dimension of the bonding surface 1a) is equal to or larger than a thickness dimension W2 of the lens 5 in a cut-end surface 5a thereof (W1 ≧W2 in the present preferred embodiment). The cut-end surface denotes, of a lens outer peripheral surface and a prism surface, a side surface extending in parallel with the optical-axis direction S, in other words, a non-optical surface irrelevant to light emission or light reflection. The cut-end surface is an optical base contacting portion of the lens 5.

In the side surfaces 3 and 4, open holes 3a and 4a are formed in a recessed shape. The open holes 3a and 4a are provided at intermediate portions on the side surfaces 3 and 4 point-contacted by the circular cut-end surface 5a of the lens 5. The positions where the open holes 3a and 4a are formed are bilaterally symmetric to each other, and the shapes of the open holes 3a and 4a are also bilaterally symmetric to each other (triangular shape in cross section). The open holes 3a and 4a are each provided at a center position along a width direction of the hollowed housing section 2 (first direction). A width dimension of the open holes 3a and 4a (length dimension along the first direction) W3 is ⅓ of a width dimension of the side surfaces 3 and 4 (length dimension along the first direction). The width dimension W3 of the open holes 3a and 4a is smaller than the thickness dimension (length dimension along the first direction) W2 of the lens 5 in the cut-end surface 5a thereof (W3 <W2). The open holes 3a and 4a are filled with the adhesive 6.

The lens 5 is housed in the hollowed housing section 2 having the shape described so far. The lens 5 is securely bonded to the bonding surface 1a with the adhesives 6 and 6 of the open holes 3a and 4a so that the optical-axis direction S thereof is substantially in parallel with the bonding surface 1a of the optical base 1. The lens 5 is placed in the hollowed housing section 2 so that a center line thereof in the thickness direction (center position of the cut-end surface 5a in the lens thickness direction) exactly overlaps on center positions of the open holes 3a and 4a in the width direction. Accordingly, entire widths of the open holes 3a and 4a contact the cut-end surface 5a of the lens 5 along the first direction. Because of the circular shape of the lens 5, the open holes 3a and 4a line-contacts the cut-end surface 5a of the lens 5 along a second direction orthogonal to the first direction (direction in parallel with the optical-axis direction of the lens 5). Therefore, the lens 5 contacts the open holes 3a and 4a so that a part of the open holes 3a and 4a is left unclosed. The center of the housed lens 5 substantially falls on a line extended from the bonding surface 1a of the optical base 1.

As described, the lens 5 is housed in the hollowed housing section 2 with the cut-end surface 5a abutting the side surfaces 3 and 4. The lens 5 housed in the hollowed housing section 2 line-contacts the intermediate portions on the side surfaces 3 and 4 of the hollowed housing section 2, and the cut-end surface 5a, except the line-contact portions thereof, is not in contact with a bottom surface 2a of the hollowed housing section 2. When the lens 5 line-contacts the intermediate portions of the hollowed housing section 2, a length dimension L1 of the open holes 3a and 4a in the second direction orthogonal to the first direction (direction in parallel with the optical-axis direction S of the lens 5) is larger than a length dimension of the contact made by the lens 5 with the side surfaces 3 and 4 in the second direction. In the present preferred embodiment wherein the lens 5 line-contacts the side surfaces 3 and 4, the length dimension of the contact is as approximate to a point as possible.

Describing the function of the optical apparatus having the structure described so far, the open holes 3a and 4a are formed in a recessed shape at portions of the side surfaces 3 and 4 line-contacted by the cut-end surface 5a of the lens 5, and the adhesive 6 is poured into the open holes 3a and 4a and stay there.

The adhesive 6 is applied into the open holes 3a and 4a and around the open holes 3a and 4a on the side surfaces 3 and 4, and the adhesive 6 makes the cut-end surface 5a of the lens 5 fixedly bonded to the side surfaces 3 and 4. The adhesive 6 is retained in a sufficient volume in the open holes 3a and 4a, and pushed out of the open holes 3a and 4a when the lens 5 is pressed against the side surfaces 3 and 4. Then, the adhesive 6 spreads upward and downward on the side surfaces (tilting surfaces) 3 and 4 and both sides of the optical base 1 in the thickness direction. As a result, the lens 5 is bonded to the side surfaces 3 and 4 with the adhesive thus adequately supplied.

Because the width dimension W3 of the open holes 3a and 4a is smaller than the width dimension W2 of the cut-end surface 5a of the lens 5, the pressure applied to the adhesive 6 by the lens 5 increases, making it easier for the adhesive 6 pushed out of the open holes 3a and 4a to spread on the side surfaces 3 and 4. The length dimension L1 of the open holes 3a and 4a is larger than the length dimension of the contact made by the lens 5 with the side surfaces 3 and 4. The contact made by the circular lens 5 with the side surfaces 3 and 4 is a line contact, and the length dimension of the contact made by the lens 5 with the side surfaces 3 and 4 is a dimension of a line connecting small contact points. In the conventional technology, there is no adhesive in a line-contact portion t as illustrated in FIG. 5B. In the present preferred embodiment technically characterized in that the open holes 3a and 4a are provided as illustrated in 5A, the open holes 3a and 4a extend below the line-contact portion t, and the adhesive 6 fully supplied contacts the cut-end surface 5a of the lens 5 including the line-contact portion t, increasing a contact area. With these technical advantages described so far combined, the lens 5 can easily fit along the side surfaces 3 and 4, and the lens 5 can be very tightly and accurately bonded to the optical base 1 with the adhesive 6 adequately supplied.

The structure according to the present preferred embodiment further contributes to the improvement of the bonding strength of the lens 5 as follows. Examples of the adhesive 6 are photo-curing resin and thermosetting resin associated with a curing reaction. These resins can exert their bonding characteristics as a result of the curing reaction. Therefore, a residual internal stress is inevitably generated in its interface with a bonding object, and ensuing imbalanced distribution of the generated residual internal stress is also unavoidable (see the problem to be solved by the present invention). The present invention successfully eliminated such an imbalanced distribution of the residual internal stress by employing the following mechanism so that the optical component mounting precision can be sustained over a long period of time.

As described earlier referring to FIG. 13, the residual internal stress generated when the adhesive 6 is cured is maximized at the center of the portion where the lens 5 is bonded to the optical base 1 in the direction in parallel with the optical-axis direction S of the lens 5. A probable theory of such an imbalanced distribution of the residual internal stress is described below. At both ends of the portion where the lens 5 is bonded to the optical base 1 in the direction in parallel with the optical-axis direction S of the lens 5 (first direction), outer sides thereof are open. Therefore, the adhesive 6 cured in the portion readily expands outward from the portion where the lens 5 is bonded to the optical base 1, dissipating the residual internal stress generated therein. The center of the portion where the lens 5 is bonded to the optical base 1 in the direction in parallel with the optical-axis direction S of the lens 5 (first direction), on the other hand, is almost entirely surrounded by the lens 5 and the optical base 1 each having a high degree of hardness. Therefore, it is difficult to dissipate the residual internal stress generated by curing the adhesive 6 at the center portion. The residual internal stress is thus differently dissipated in the different portions, which is a likely cause of the imbalancedly distributed residual internal stress.

Based on the analyzed mechanism of the residual internal stress, the open holes 3a and 4a are selectively provided at the center positions of the lens contacting portions in the bonding surface 1a of the optical base 1 (more specifically, bonding surfaces 3 and 4 of the hollowed housing section 2) in the first direction in parallel with the optical-axis direction S of the lens 5 (where the residual internal stress is maximized).

More specifically, the open holes 3a and 4a dimensionally characterized as follows are provided in the lens contacting portions of the side surfaces 3 and 4.

having the width dimension S3 smaller than the thickness dimension W2 of the lens 5 in the cut-end surface 5a, and
having the length dimension L1 adequately larger than the length dimension of the contact made by the lens 5 with the side surfaces 3 and 4 in the direction orthogonal to the optical-axis direction of the lens 5 (points in the present preferred embodiment).

Accordingly, a part of the open holes 3a and 4a has no contact with the lens 5, and the residual internal stress generated when the adhesive 6 is cured (maximized at the center of the portion where the lens 5 contacts the optical base 1 in the thickness direction of the lens 5) is speedily absorbed well by the adhesive 6 stored in the open holes 3a and 4a and then dissipated. As a result, imbalance of a residual internal stress distribution 7 of the post-drying adhesive 6 is lessened as illustrated in FIG. 5, and the lens 5 can be bonded precisely at the right position over a long period of time.

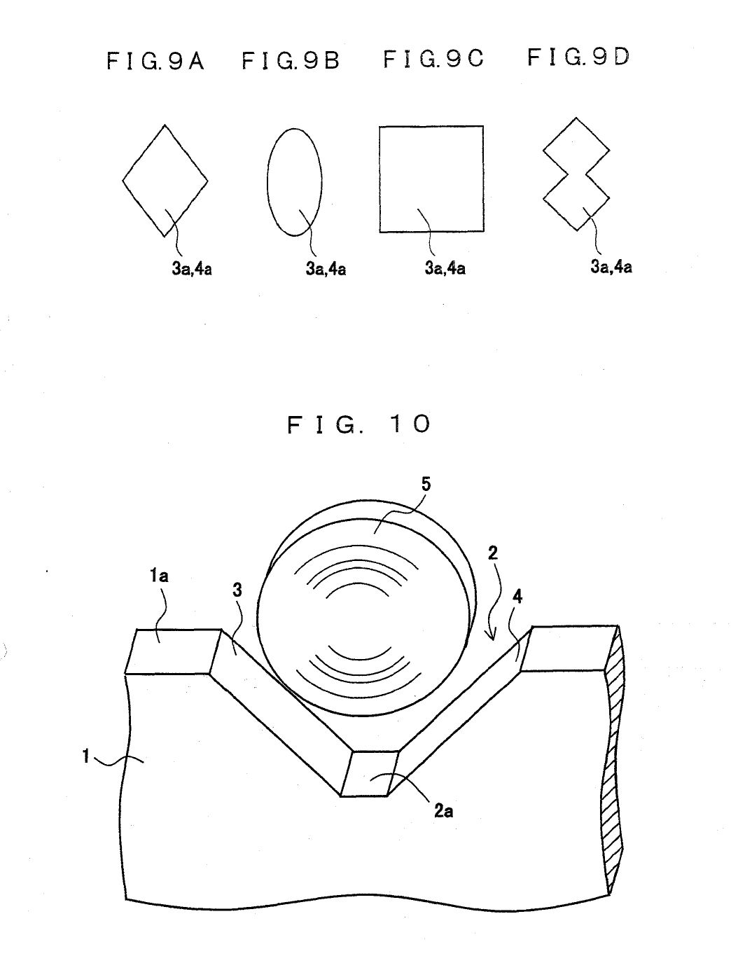

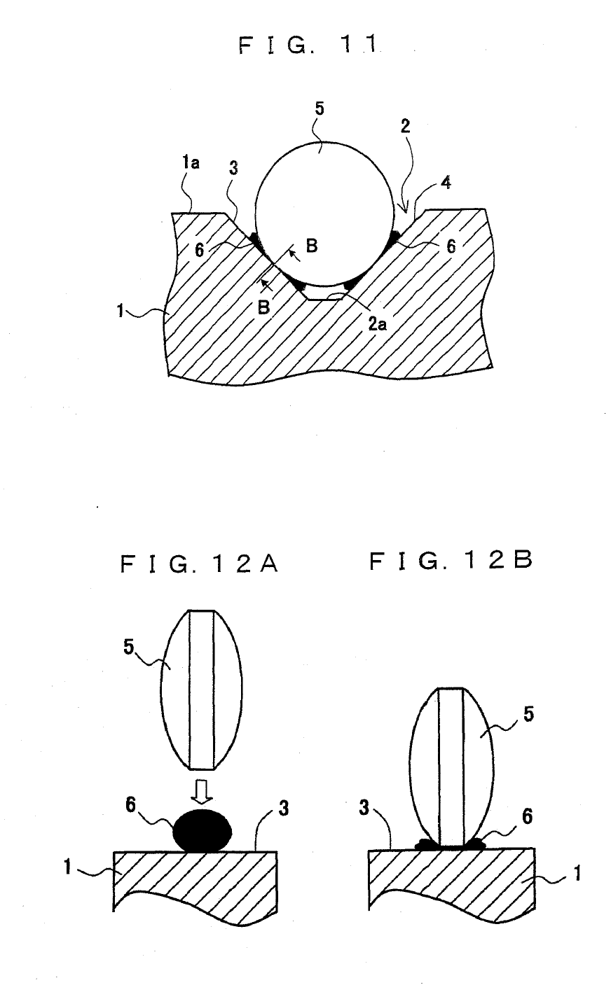

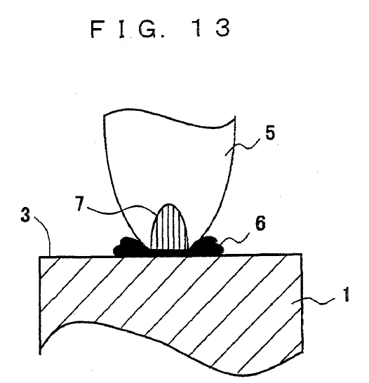

The planar shape of the open holes 3a and 4a is not particularly limited, and any of the shapes illustrated in FIGS. 9A-9D may be used. The sectional shape of the open holes 3a and 4a may be a shape other than the triangular shape (rectangular or circular shape). The opening angle of the bilaterally-paired side surfaces 3 and 4 is not necessarily limited to 90 degrees, and the tilt angle may be an angle other than 45 degrees. Further, the bilateral symmetry is not particularly necessary.

In the description of the preferred embodiment 1 given so far, the shape of the hollowed housing section 2 is triangular in view from the optical-axis direction S, and the lens 5 abuts the hollowed housing section 2 at two positions. A possible alternative option is to form the side surfaces of the hollowed portion in a polygonal shape so that the lens 5 abuts the hollowed housing section 2 at three or more positions, in which case the open holes 3a and 4a are provided at any lens contacting positions.

The width dimension W3 of the open holes 3a and 4a is not necessarily approximately ⅓ of the thickness direction W1 of the side surfaces 3 and 4. The shape of the lens 5 is not particularly limited to the true circle, and the center of the lens 5 may be deviated from the line extended from the outer end surface of the optical base. The lens 5 may be any of a concave lens, convex lens, and combination of these lenses.

A method for manufacturing the optical pickup apparatus 100 according to the present preferred embodiment is described below. The description given below focuses on a method for mounting the lens 5 on the optical base 1 which represents the technical characteristic of the present preferred embodiment.

First Step

First, the hollowed housing section 2 is formed in the optical base 1, and the open holes 3a and 4a are then formed in the side surfaces 3 and 4 of the hollowed housing section 2. The formed open holes 3a and 4a are filled with the adhesive 6. The open holes 3a and 4a are formed so that the length dimension W3 of the open holes 3a and 4a along the first direction in parallel with the optical-axis direction S is smaller than the length dimension W2 of the optical base contacting portion of the lens 5 along the first direction (W3 <W2). Further, the open holes 3a and 4a are formed so that the length dimension L1 of the open holes 3a and 4a along the second direction orthogonal to the first direction is larger than the length dimension of the optical base contacting portion of the lens 5 along the second direction (the lens 5 makes point contacts in the present preferred embodiment). Then, the hollowed housing section 2 tapered downward in view from the optical-axis direction S of the lens 5 is formed in the side surfaces 3 and 4. Further, the hollowed housing section 2 is formed so that the length dimension W1 of the hollowed housing section 2 along the first direction is equal to or larger than the length dimension W2 of the optical base contacting portion of the lens 5 (cut-end surface 5a) along the first direction (W1 W2).

Second Step

Then, the lens 5 is mounted on the side surfaces 3 and 4 so that the lens 5 contacts the open holes 3a and 4a with a part of the open holes 3a and 4a making no contact with the lens 5 (a part of the open holes 3a and 4a is left unclosed). The lens 5 is mounted on the side surfaces 3 and 4 so that the entire width of the open holes 3a and 4a along the first direction contacts the lens 5.

Third Step

Finally, the adhesive 6 is cured so that the lens 5 is securely bonded to the side surfaces 3 and 4.

### Preferred Embodiment 2

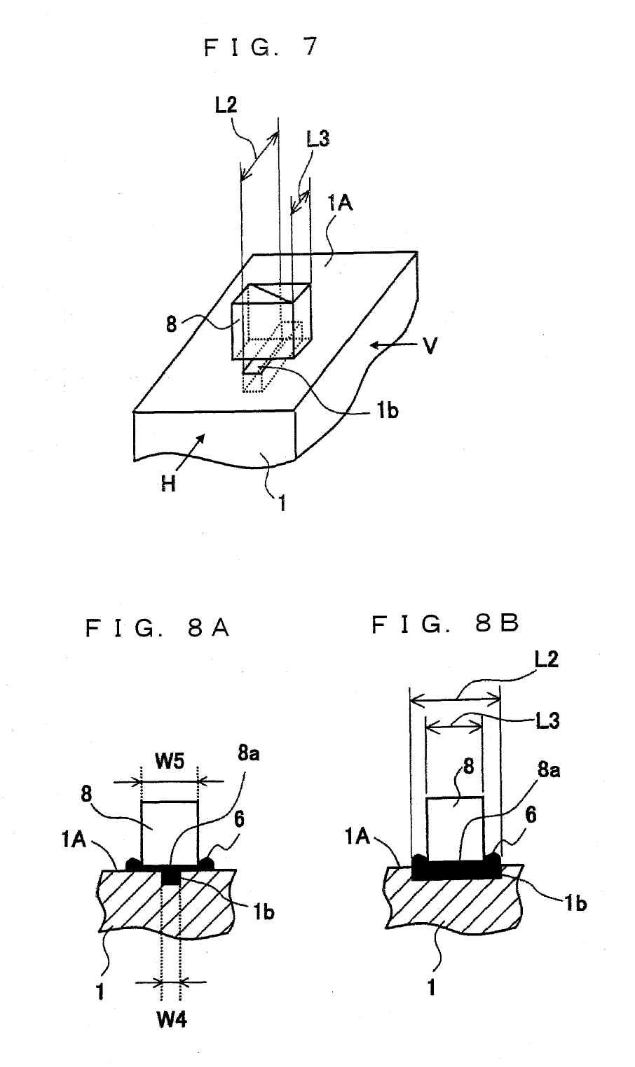

In the preferred embodiment 1, the lens is used as the optical component. A preferred embodiment 2 of the present invention relates to an optical apparatus wherein a prism 8 having a tetragonal shape is mounted as the optical component. FIG. 7 is a perspective view of an optical base securing portion of the prism 8 in the optical pickup apparatus according to the preferred embodiment 2. FIG. 8A is a sectional view of the optical base securing portion in view from a direction H (first direction) illustrated in FIG. 7 (corresponding to FIG. 6), and FIG. 8B is a sectional view of the optical base securing portion in view from a direction V (second direction) of FIG. 7. In the present preferred embodiment, the direction V when the prism 8 is fixed to the optical base 1 (see FIG. 7) is in parallel with an optical-axis direction of the prism 8.

A rectangular open hole 1b is formed in a recessed shape in the bonding surface 1A of the optical base 1. A width dimension (length dimension) W4 of the open hole 1b along a first direction in parallel with the optical-axis direction of the prism 8 (direction V) is smaller than a thickness dimension (length dimension along the first direction) W5 of a cut-end surface 8a of the prism 8 (W4 <W5). Further, a length dimension L2 of the open hole 1b along a second direction (direction H) orthogonal to the first direction (direction V) in parallel with the bonding surface 1A and the optical-axis direction of the prism 8 is larger than a length dimension L3 of the contact made by the prism 8 with the bonding surface 1A in the second direction (direction H) (L2 >L3).

The prism 8 abuts the bonding surface 1A so that center lines thereof exactly overlaps on center lines of the open hole 1b in both of the first and second directions. A portion of the bonding surface 1A abutted by the prism 8 is coated with the adhesive 6, and the open hole 1b is filled with the adhesive 6. When the prism 8 is pressed against the bonding surface 1A, the adhesive 6 is subject to the pressure from the prism 8 in a manner similar to the preferred embodiment 1, and the adhesive 6 thereby pushed out of the open hole 1b spreads on the bonding surface 1A. As a result, the adhesive 6 thus spreads thereon in an adequate volume bonds the prism 8 to the bonding surface 1A with a high precision. In a manner similar to the preferred embodiment 1, imbalanced distribution of the residual internal stress of the post-drying adhesive 6 is lessened, and the bonding strength of the prism 8 can be sustained over a long period of time.

The optical components in the description of the preferred embodiments 1 and 2 were the lens 5 and the prism 8. The present invention can be similarly applied to other optical components such as a polarizing plate and a photodetector.

An optical pickup apparatus equipped with the optical apparatus according to the preferred embodiment 1 or 2 and an optical disc drive apparatus equipped with the optical pickup apparatus are advantageous in that a high mounting precision is sustained over a long period of time in optical components such as a lens, prism, polarizing plate and photodetector. Therefore, these apparatuses can reliably and accurately perform tracking control and focus control using an optical pickup.

With a higher precision increasingly demanded in assembling optical components to deal with increasingly shorter wavelengths of a semiconductor laser for achieving a higher recording density, the optical apparatuses according to the preferred embodiments can meet the demand. Further, the optical apparatuses that are resistant to deterioration over time can improve reliability in an environment under difficult conditions, for example, an in-vehicle optical disc drive apparatus.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. An optical apparatus comprising:
an optical base having a bonding surface; and
an optical component fixedly bonded to the bonding surface with an adhesive, wherein
the optical base has an open hole formed in the bonding surface,
the open hole is filled with the adhesive, and
the optical component contacts the open hole so that a part of the open hole is left unclosed.

2. The optical apparatus as claimed in Claim 1, wherein
a length dimension of the open hole along a first direction in parallel with an optical-axis direction of the optical component is smaller than a length dimension of an optical base contacting portion of the optical component along the first direction.

3. The optical apparatus as claimed in Claim 2, wherein
an entire width of the open hole along the first direction is in contact with the optical component.

4. The optical apparatus as claimed in Claim 2, wherein
a length dimension of the open hole along a second direction orthogonal to the first direction is larger than a length dimension of the optical base contacting portion along the second direction.

5. The optical apparatus as claimed in Claim 1, wherein
an optical base contacting portion of the optical component has the shape of a bulging curved surface in view from an optical-axis direction of the optical component.

6. The optical apparatus as claimed in Claim 1, wherein
the optical base has a hollowed housing section tapered downward in view from an optical-axis direction of the optical component in the bonding surface, a length dimension of the hollowed housing section along a first direction in parallel with the optical-axis direction is equal to or larger than a length dimension of an optical base contacting portion of the optical component along the first direction, and the open hole is provided in each of side surfaces of the hollowed housing section.

7. The optical apparatus as claimed in Claim 1, wherein
the bonding surface and an optical base contacting portion of the optical component respectively have the shape of a flattened surface.

8. An optical pickup apparatus comprising:
a light source;
the optical apparatus clamed in Claim 1 for introducing a luminous flux from the light source to an optical disc; and
a light-sensitive element for receiving the luminous flux reflected from the optical disc.

9. An optical disc drive apparatus comprising:
the optical pickup apparatus clamed in Claim 8; and
a servo control apparatus for focus-controlling the optical pickup apparatus.

10. A method for manufacturing an optical apparatus comprising an optical base having a bonding surface and an optical component fixedly bonded to the bonding surface with an adhesive, including:
a first step for forming an open hole in the bonding surface and filling the open hole with the adhesive;
a second step for mounting the optical component on the bonding surface so that the optical component contacts the open hole with a part of the open hole making no contact with the optical component; and
a third step for fixedly bonding the optical component to the bonding surface by curing the adhesive.

11. The method for manufacturing an optical apparatus as claimed in Claim 10, wherein
the open hole is formed in the first step so that a length dimension of the open hole along a first direction in parallel with an optical-axis direction of the optical component is smaller than a length dimension of an optical base contacting portion of the optical component along the first direction.

12. The method for manufacturing an optical apparatus as claimed in Claim 11, wherein
the optical component is mounted on the bonding surface in the second step so that an entire width of the open hole along the first direction is in contact with the optical component.

13. The method for manufacturing an optical apparatus as claimed in Claim 11, wherein
the open hole is formed in the first step so that a length dimension of the open hole along a second direction orthogonal to the first direction is larger than a length dimension of the optical base contacting portion along the second direction.

14. The method for manufacturing an optical apparatus as claimed in Claim 10, wherein
an optical base contacting portion of the optical component has the shape of a bulging curved surface in view from an optical-axis direction of the optical component.

15. The method for manufacturing an optical apparatus as claimed in Claim 10, wherein
a hollowed housing section tapered downward in view from an optical-axis direction of the optical component is formed in the bonding surface, a length dimension of the hollowed housing section along a first direction in parallel with the optical-axis direction is set to a value equal to or larger than a length dimension of an optical base contacting portion of the optical component along the first direction, and the open hole is provided in each of side surfaces of the hollowed housing section in the first step.

16. The method for manufacturing an optical apparatus as claimed in Claim 10, wherein
the bonding surface and an optical base contacting portion of the optical component respectively have the shape of a flattened surface.
